(19) United States
(12) Patent Application Publication
(10) Pub. No.: US 2010/0269483 A1
(43) Pub. Date: Oct. 28, 2010

(54) ION PROPULSION EMITTER AND METHOD FOR THE PRODUCTION THEREOF

(76) Inventor: Andrea Novi, Pontedera (IT)

Correspondence Address: MCGLEW & TUTTLE, PC, P.O. BOX 9227, SCARBOROUGH STATION, SCARBOROUGH, NY, 10510-9227, US

(21) Appl. No.: 12/747,005

(22) PCT Filed: Jul. 3, 2008
(86) PCT No.: PCT/IT08/00446

§ 371 Date: Jun. 9, 2010

(51) Int. Cl. F03H 1/00; B64G 1/22; B24B 1/00; B23P 11/00

(52) U.S. Cl. 60/202; 451/41; 29/428

(57) ABSTRACT

The emitter for ion propulsion comprises: —two mutually coupled semi-emitters (3, 5), made of optical material, each of which presents a respective sharpened end; the two ends (3D, 5D) form a tip in correspondence of which there is a recess (15) for the diffusion of a propellant, obtained between said two semi-emitters; and —an adduction conduit (17) for adduction of the propellant to the recess (15).

### TECHNICAL FIELD

The present invention relates to an ion propulsion emitter typically used in order to maintain the spatial satellites in position.

### STATE OF THE ART

The emitters for ion propulsion engines, also called FEEP (Field Emission Electric Propulsion) emitters, are the heart of the low-thrust and low-consumption ion engines used in order to maintain the position of the orbiting satellites.

An emitter is formed from two coupled semi-emitters, each of which has an end or edge sharpened at a high-precision micrometric level. The two parts are tight coupled by means of screws and bolts and have, on the two faces or surfaces in reciprocal contact, a recess, into which a liquid propellant, typically cesium or the like, is infiltrated. The recess is obtained on the coupling surface of one or both the semi-emitters through vacuum-deposition of a thin film, for example vacuum deposition of a silicon oxide or other material, with such a profile so as to form an exit path for the liquid cesium, or other propellant, with micrometric height and with outfall on the useful tip of the emitter, i.e. on the end formed by the coupling of the two sharpened ends or edges of the two semi-emitters. The propellant acts as a propeller when by capillarity it faces the sharpened end of the two semi-emitters, where, due to the concentration of the electric field, detachment and concentration of ions occur, proportional to the difference of adjustable potential with respect to a cathode duly arranged in front of the sharpened end of the semi-emitters.

The sharpening grade, i.e. the radius of curvature of the section of the sharpened edge, in the order of a micrometer, the accuracy of this end or edge straightness of few micrometers and the lack of defects are pre-requirements for the operation, the efficacy of the thrust and reliability or useful working life of the engine. This latter aspect is particularly sensitive, as these are equipment to be installed on the satellite, and therefore it is very difficult to perform repair or maintenance operations. Currently, the semi-emitters of an emitter for ion engine are constructed with metallic materials, which must meet a plurality of physical-chemical requirements: compatibility and wettability with the propellant, adequate electro-magnetic properties, mechanical properties of thermo elastic stability and mechanical processability for high precision and low defectability.

The metallic materials which meet this set of requirements are relatively few, typically some steels, nickel alloys such as Inconel and similar. They present, to a different extent, respective advantages and disadvantages. In any case, the common features of the metallic materials is the electric conductivity, which imposes construction of extremely sharpened ends (sections with low angles) in order to obtain electric fields concentrated on the tips of the semi-emitters.

### OBJECTS AND SUMMARY OF THE INVENTION

According to one aspect, the invention provides a new semi-emitter for ion propulsion engines, which has many advantages with respect to the emitters and semi-emitters currently known.

The object of one embodiment of the invention is to provide a semi-emitter, which has an extremely high sharpening grade, i.e. a very small radius of curvature, which can be obtained through particularly simple workings.

The object of a further preferred embodiment of the invention is to provide a semi-emitter, which is not affected by the drawbacks of the semi-emitters made of conductive material.

According to one embodiment, the invention provides an ion-propulsion emitter including: two mutually coupled semi-emitters, each of which has a respective sharpened end or edge, the two ends forming a tip, in correspondence of which a recess for the diffusion of a propellant leads, which is obtained between said two semi-emitters. Into the recess a conduit for propellant adduction streams. The two semi-emitters are made of optical material. With the term “optical material” it is intended generally a material suitable to be worked through a grinding and polishing technology, which is typical for the optical processing, for example through abrasion. According to some embodiments, the optical material of which the two semi-emitters are made can be: glass; quartz; ceramic; glass ceramic; a metalloid; an electro-optical crystal.

In some embodiments, on at least one semi-emitter a layer is provided of a material, which is vacuum deposited on the coupling surface along which the semi-emitter is coupled to the other semi-emitter. The layer of vacuum deposited material forms a gasket with the opposite surface of the other semi-emitter, which can be provided with a layer of vacuum deposited material as well. Preferably, the recess for diffusion of the propellant is formed by a zone of the main surface of the one or the other or both the semi-emitters, which is void of the above mentioned layer of vacuum deposition. In this case, the cross section of the diffusion recess is defined by the thickness of the layer or of the layers vacuum deposited on one or both the semi-emitters.

The layer of vacuum deposited material can be formed from any material compatible with the base material which forms the respective semi-emitter and which can be vacuum deposited. Preferably, this material is electrically non-conductive, for example a metal oxide or preferably silicon oxide.

According to some embodiments, at least one of the semi-emitters has a meatus for capillary diffusion in said recess, extending from said adduction conduit to a position near said tip. This meatus can be obtained through photoengraving of the coupling surface through which the semi-emitter is coupled to the other semi-emitter.

According to a different aspect, the invention relates to a method for producing a semi-emitter for ion propulsion engines. Substantially, according to this aspect, in one embodiment the invention provides a working method comprising the steps of:
a) providing a plate of material with a first and a second main plane surface;
b) polishing an outer face defining a functional end of the semi-emitter, said face forming a predetermined angle with said first main plane surface of the plate;
c) applying to said polished outer face, defining the functional end of the semi-emitter, an auxiliary element presenting a polished outer face, which is applied to the outer face defining the functional end of the semi-emitter, and a main plane surface, which is substantially aligned with the first main surface of the plate;
d) polishing the plane surface defined by the first main plane surface of said plate and by said main plane surface of said auxiliary element, substantially coplanar to each other and aligned in such a way so as to sharpen the edge defined by the intersection between the outer face and the first main plane surface of said semi-emitter.

According to some preferred embodiment of the invention, the polished outer face defining the functional end of the semi-emitter and the outer face polished by the auxiliary element are connected to each other through a glue, in order to perform polishing of the two main plane surfaces, and subsequently detached through removal of the glue.

Further features and advantageous embodiments of the emitter according to the invention and of the method for the production thereof are set forth in the appended claims and shall be described hereunder with reference to non-limiting embodiments.

### BRIEF DESCRIPTION OF THE DRAWINGS

The invention will be easier to understand by means of the description below and the attached drawing, which shows a non-restrictive practical embodiment of the invention. More in particular, in the drawing:

FIG. 1 shows a longitudinal section according to I-I of FIG. 2 of an emitter according to the invention;

FIG. 2 shows a view according to II-II of FIG. 1 of the surface through which an emitter is coupled to the other;

FIG. 3 shows a front view according to III-III of FIG. 1;

FIG. 4 shows a working phase of a semi-emitter in a side view; and

FIG. 5 shows a top view according to V-V of FIG. 4.

### DETAILED DESCRIPTION OF AN EMBODIMENT OF THE INVENTION

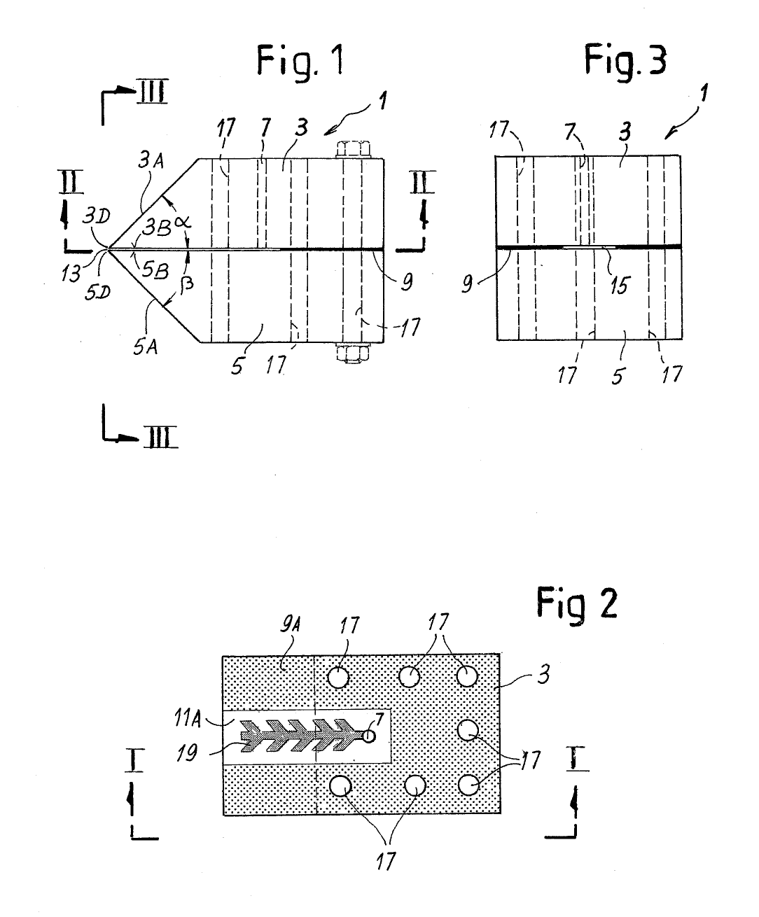

FIGS. 1, 2, and 3 schematically show an emitter according to the invention indicated in its entirety with the number 1. The emitter comprises a first semi-emitter 3 and a second semi-emitter 5. The two semi-emitters 3 and 5 are substantially identical, except for the fact that the semi-emitter 3 has an adduction hole or conduit 7 for adduction of the propellant, for example cesium or other, whilst the semi-emitter 5 is devoid of it. Only the semi-emitter 3 will be therefore described in greater detail hereunder, being understood that the semi-emitter 5 has similar features and can be obtained through the same process described hereunder with reference to the semi-emitter 3, except from the phase of producing the adduction conduit or hole 7 for adduction of the propellant.

The semi-emitters 3, 5 can be made of glass, pure silicon (quartz), ceramic material, glass ceramic or any other material preferably electrically non-conductive and which can be worked through abrasion with optical working techniques.

Each of the two semi-emitters has a front surface or outer face 3A and 5A respectively, inclined by an angle α and an angle β respectively, with respect to main surfaces 3B and 5B of mutual coupling. The front surfaces or outer faces 3A, 5A define a respective functional end of each semi-emitter.

In the example illustrated, the angles α and β are identical, but is must be understood that this is not strictly necessary. The angles α and β have values preferably greater than 10°, and more preferably greater than 20°; according to some embodiments the angles α and β are equal or greater than 25° and more preferably greater than 30°. In an illustrated embodiment the angle α and the angle β are identical and preferably equal to or greater than 40°, for example equal to 45°. These particularly high angle can be obtained thanks to the use of non-conductive materials in the production of the semi-emitters 3, 5; these materials allow the production of less sharpened tips, although characterized by an end angle with a radius of curvature which is improved by a factor 2 with respect to the radius of curvature which can be obtained with the working of metallic semi-emitters.

On the two main surfaces or coupling surfaces 3B and 5B of the two semi-emitters a vacuum deposition layer is obtained, indicated with 9A for the semi-emitter 3 in FIG. 2 and generically with 9 in FIGS. 1 and 3. Preferably, the vacuum deposition layer is obtained on both the faces 3B and 5B, but it must be understood that in some cases it can be provided on only one of the semi-emitters 3, 5. On one or both the surfaces 3B, 5B the vacuum deposition layer has an interruption, i.e. the respective main surface 3B or 5B has an area devoid of the vacuum deposition coating layer. In FIG. 2 this area is indicated with the number 11A. In the illustrated embodiment, also the deposition layer provided on the main face or surface 5B of the semi-emitter 5 has a similar area devoid of deposition, but it shall be understood that this is not strictly necessary.

In other embodiments, the vacuum deposition layer on one of the two semi-emitters can be continuous and only the other provided with an interruption area which forms the cavity in which the propellant, fed through the adduction conduit 7, filters through capillarity effect to the front tip 13 of the emitter 1 defined by two sharpened edges 3D, 5D of the two semi-emitters 3, 5, mutually adjacent and coupled. The edges 3D and 5D are obtained in the sharpened end of each semi-emitter 3, 5 and are defined by the intersection of the front surface or face 3A or 5A and of the main base surface 3B, 5B. The area 11A devoid of deposition opens in correspondence of the tip 13 of ion emission, as it can be seen in particular in the front view of FIG. 3, where number 15 indicates the outlet of the cavity defined by the area or the areas 11A devoid of the coating layer 9, 9A.

The layer 9, 9A can be obtained through deposition of metallic material or preferably metallic oxide, or silicon oxide or other material preferably non-conductive. Generally, the layer will be obtained from a material which can be vacuum deposited, compatible with the base material forming the semi-emitter and preferably electrically non-conductive.

The two semi-emitters 3 and 5 are mutually coupled by means of screws and bolts, not shown, which are inserted across through holes 17 provided in the bodies of the two semi-emitters 3, 5. The holes 17 are obviously obtained in areas distant from the cavity of propellant infiltration and capillary diffusion, defined by the area 11A, in such a way so as to avoid leakages of propellant.

According to some embodiments, the surface of the base material of at least one of the semi-emitters 3, 5 can be engraved in the area 11A through a photoengraving process, as shown in 19 for the semi-emitter 3 (FIG. 2). This engraving forms a meatus for capillary diffusion of the liquid propellant. The depth of the engraved area and thus the section of the meatus can be variable from the end corresponding to the adduction hole or conduit 7 to the area near the tip 13, i.e. at the sharpened end or edge of the semi-emitter 3 or 5. Preferably, the photoengraved area however does not reach the front edge defining the sharpened end of the body of the semi-emitter 3, 5. In this way, an auxiliary cavity is defined of capillary propagation of the liquid propellant from the adduction conduit 7 to an area near to the front tip 13 defined by the sharpened opposite edges of the two semi-emitters, from which the ions are emitted in order to generate the propelling thrust of the ion engine in which the emitter 1 is incorporated. The variable depth decreasing from the adduction hole 7 to the proximity of the front sharpened edge of the semi-emitter facilitates capillary propagation of the liquid propellant. As preferably the photoengraving does not reach the sharpened edge of the semi-emitter, this edge is not damaged by the photoengraving and it maintains its radius of curvature extremely reduced obtained through the process described hereunder.

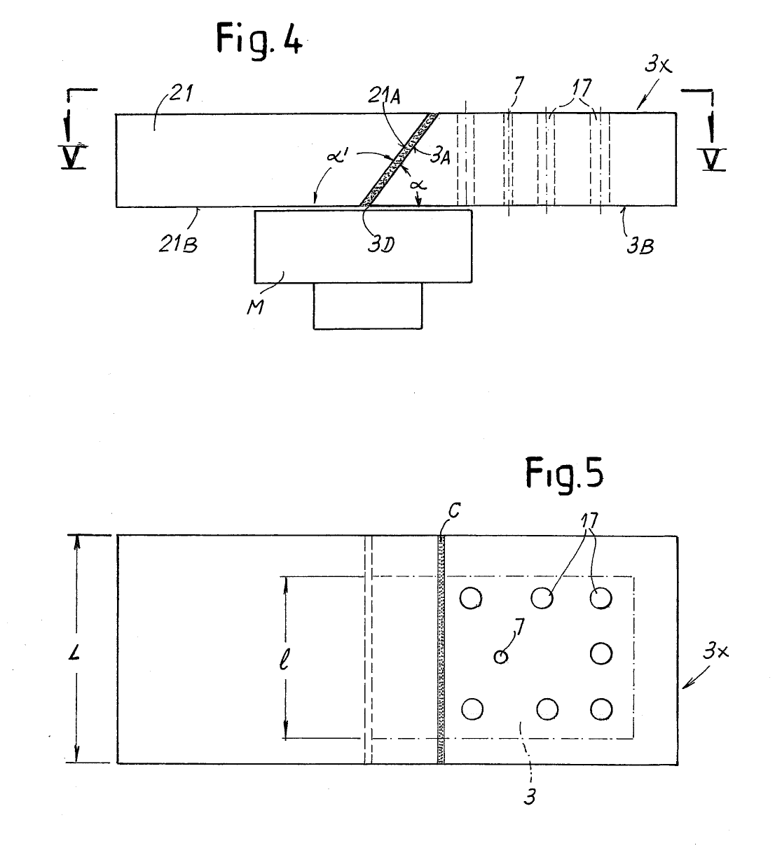

Each of the semi-emitters 3, 5 can be obtained by working a plate of base material through a process described with specific reference to FIGS. 4 and 5.

3X indicates the starting plate, from which the semi-emitter 3 is obtained. This plate presents a width L greater than the width (I), which the emitter obtained therefrom shall have. The working starts with a grinding and polishing process of the front surface or face 3A, defining the functional end of the semi-emitter, inclined by the angle a with respect to the main base surface 3B. This working is carried out through a process typical of the optical works and by means of abrasive and polishing tools used in this technological sector.

When the polishing of the surface 3A defining the functional end of the semi-emitter has been obtained, to this surface 3A is coupled a complementary surface 21A of a complementary or auxiliary element 21, also obtained preferably in an optical material, i.e. in a material which can be optically processed. The surface 21A forms together with a base surface 21B of the block 21 an angle α^{l} complementary to the angle α, i.e. such that α+α¹=180°. The surfaces 3B and 21B are aligned in such a way to be substantially coplanar as shown in FIG. 4. The surfaces 3A and 21A mutually in contact are preferably glued with an adhesive or glue C for vitreous materials. When the plate 3X and the auxiliary complementary element 21 have been coupled together in the manner described above, the substantially coplanar surfaces 3B, 21B are processed by grinding and optical polishing through a grinding wheel M, such as to generate the sharpened edge 3D defined by the intersection between the polished plane surface 3B and the polished plane surface 3A. This edge, coupled with an analogous sharpened edge obtained through the same process on another plate in order to form the semi-emitter 5, will form the emission tip 13 of the emitter 1.

When the surfaces 3B and 21B have been polished, the holes 17 for mechanical coupling of the semi-emitter 3 with the semi-emitter 5, as well as the propellant adduction hole or conduit 7 are machined. The process of drilling in order to form the conduit 7 is not carried out for the semi-emitter 5, which however will undergo the same machining described above for the semi-emitter 3.

The sequence of the machining operations can also vary with respect to the one described above. For example, drilling the conduit 7 can be performed before or after drilling the holes 17, and furthermore these holes, 7, 17, can be obtained before or after grinding or polishing the surfaces 3B, 21B.

When these machining operations have been carried out, the plate 3X can be cut to-measure in order to obtain the semi-emitter 3, i.e. reducing the width L of the plate until to obtain the width I equal to the width of the semi-emitter. In this way it is possible to eliminate from the part of plate 3X destined to form the semi-emitter 3 any machining defect on the ends of the edge 3D.

The plate cut to the desired length by eliminating the rear end opposite to the edge 3D, can be detached from the auxiliary complementary element 21 in a suitable manner by using for example a solvent for the adhesive C used in the coupling of the inclined complementary surfaces 3A, 21A. In some embodiments it is possible to perform the detachment of the plate 3X from the auxiliary complementary element 21 before cutting at the desired dimension the plate 3X.

When these machining operations have been performed, the final processing operations are carried out, which comprise among other things the vacuum deposition of the layer 9, 9A on the base surface or main surface 3B for coupling the semi-emitter 3 on the semi-emitter 5 and/or eventually vacuum deposition of this layer on the corresponding main or base surface of the semi-emitter 5.

During the process described above, in an adequate phase photoengraving 19 is also carried out.

The process described above has the advantage of obtaining in a relatively fast and repetitive manner a radius of curvature of the front edge 3D in the order of micrometer improving, i.e. reducing the radius of curvature by a factor equal to about 2 with respect to the radius of curvature which can be obtained through machining of metallic blocks according to the state of the art. It has also been noted that this edge is obtained devoid of defects even after the detachment in solution of the service adhesive, i.e. of the glue C used for temporarily engaging the plate 3X with the auxiliary complementary element 21, notwithstanding the fragility typical of the vitreous materials used in the production of said components 3X and 21.

This represents a great advantage with respect to the processing of metallic semi-emitters, in which the tip is obtained through subsequent sharpening of the two edges or faces of the blade, sharpening which results in defects which can not be avoided simply because of the angle of tip which is particularly reduced with respect to the angle which can be used with vitreous materials, angle which is necessary due to the conductivity of the material and the plastic character of the metal.

Furthermore, as in the process according to the invention the second semi-emitter is obtained from a plate 3X with dimensions in width L greater than the width I of the semi-emitter, the straightness of the sharpened edge 3D does not change during optical processing at least of the central parts of the plate made of glass or other vitreous analogous material from which the semi-emitter 3 or 5 is obtained by cutting of lateral portions.

Lastly, on the vitreous material on which the semi-emitters 3, 5 according to the invention have been obtained, through photoengraving it is possible to obtain the cavities 19 with variable shapes and depths, in such a way so as to optimize the phenomena of capillarity and uniformity of diffusion of the liquid propellant in the recess obtained in the area 11A of diffusion of the propellant from the adduction conduit 7 to the tip 13 of the emitter 1.

It is understood that the drawing only shows an example provided by way of a practical arrangement of the invention, which can vary in forms and arrangement without however departing from the scope of the concept underlying the invention. Any reference numerals in the appended claims are provided for the purpose of facilitating reading thereof with reference to the description and to the drawing and do not limit the scope of protection represented by the claims.

1. An ion propulsion emitter comprising:
two mutually coupled semi-emitters, each of said semi-emitters having a respective sharpened end, said sharpened end of one of said semi-emitters and said sharpened end of another one of said semi-emitters forming a tip, in correspondence of which a recess for the diffusion of a propellant opens, said recess being provided between said two semi-emitters; and
an adduction conduit for adducting propellant to said recess wherein said semi-emitters are made of optical material.

2. An emitter as claimed in claim 1, wherein said optical material is chosen from the group comprising: glass; quartz; ceramic; glass ceramic; metalloids; electro-optical crystal.

3. An emitter as claimed in claim 1, wherein said sharpened end of the two semi-emitters is obtained through abrasion machining of the material forming the semi-emitter.

4. An emitter as claimed in claim 1, wherein on at least one of the semi-emitters a layer of a vacuum deposited material is provided forming a tight surface.

5. An emitter as claimed in claim 4, wherein said layer of vacuum deposited material is provided on both the semi-emitters, in order to form surfaces for mutual coupling.

6. An emitter as claimed in claim 4, wherein said at least one layer of vacuum deposited material has an interruption, in such a way so that the layer of vacuum deposited material delimits said recess, leaving a connection between said recess and said tip.

7. An emitter as claimed in claim 4, wherein said layer of vacuum deposited material is formed by an oxide.

8. An emitter as claimed in claim 7, wherein said oxide is silicon oxide (Si^{O}₂).

9. An emitter as claimed in claim 1, wherein at least one of said semi-emitters has a meatus for diffusion through capillarity in said recess, extending from said adduction conduit to a position adjacent to said tip.

10. An emitter as claimed in claim 9, wherein said meatus has a depth decreasing from said adduction conduit to said tip.

11. An emitter as claimed in claim 9, wherein said meatus is obtained by photoengraving.

12. An emitter as claimed in claim 1, wherein said sharpened end of each semi-emitter is defined by two plane convergent faces of the semi-emitter which form together an angle greater than 20°, preferably greater than 30° and more preferably greater than 40°, for example about 45°.

13. A method for working a semi-emitter of an ion propulsion emitter, the method comprising the steps of:
providing a plate of optical material with a first and a second main plane surface;
polishing an outer face defining a functional end of the semi-emitter, said face forming a predetermined angle with said first main plane surface of the plate;
applying to said polished outer face defining the functional end of the semi-emitter an auxiliary element made of optical material and having a polished outer face, which is applied to the outer face defining the functional end of the semi-emitter, and a main plane surface, which is substantially aligned with the first main surface of the plate;
polishing the plane surface defined by the first main plane surface of said plate and by said main plane surface of said auxiliary element, substantially coplanar to each other and aligned in such a way so as to sharpen the edge defined by the intersection between the outer face and the first main plane surface of said semi-emitter.

14. A method as claimed in claim 13, wherein said polished outer face defining the functional end of the semi-emitter and said outer polished face of the auxiliary element are connected to each other by a glue, in order to perform polishing of the two main plane surfaces, and subsequently detached through removal of the glue.

15. (canceled)

16. A method as claimed in claim 13, wherein said plate is cut orthogonally to said edge.

17. A method as claimed in claim 13, wherein said plate is perforated in order to form an adduction conduit of a propellant.

18. A method as claimed in claim 13, further comprising a step of drilling the plate for forming through holes for blocking elements of the complementary semi-emitter.

19. A method as claimed in claim 13, further comprising a phase of vacuum deposition of a tight layer on the first main plane surface of said plate.

20. A method as claimed in claim 19, wherein said tight layer is obtained by leaving free a portion of said main plane surface confining with the edge defined by the main plane surface and by said polished face of said plate.

21. A method as claimed in claim 20, wherein said portion of surface is photoengraved, to obtain one or more meatuses for feeding the propellant by capillarity from said adduction conduit towards said edge.

22. A method as claimed in claim 21, wherein said meatus or said meatuses terminate at a given distance from the edge of the plate.

23. A method as claimed in claim 21, wherein said meatuses are engraved with depth variable and decreasing from the adduction channel towards said edge.

24. An emitter as claimed in claim 2, wherein said sharpened end of the two semi-emitters is obtained through abrasion machining of the material forming the semi-emitter.
